(19) United States
(12) Patent Application Publication
(10) Pub. No.: US 2003/0157214 A1
(43) Pub. Date: Aug. 21, 2003

(54) Graft copolymers of polyhydroxy compounds and method of use

(76) Inventors: Patrick V. Bonsignore, Channahon, IL (US); Michael H. Gurin, Glenview, IL (US)

Correspondence Address: David G. Rosenbaum, ROSENBAUM & ASSOCIATES, P.C., Suite #3653, 875 North Michigan Avenue, Chicago, IL, 60611, US

(21) Appl. No.: 10/078,179

(22) Filed: Feb. 19, 2002

(51) Int. Cl. A23G 3/30

(52) U.S. Cl. 426/3

(57) ABSTRACT

A composition comprised of graft copolymers of polyhydroxy compounds. The resulting high molecular weight grafted polyhydroxyl polymer can be used for applications taking advantage of the improved physical properties. The composition comprises monomeric and polymeric hydroxyl-substituted compounds, and grafting segments as selected from the group of α-hydroxyalkanoic acids, β-hydroxyalkanoic acids, and other polyesters. The composition provides an effective method to create an environmentally acceptable chewing gum comprising the steps of creating a chewing gum base that includes a sufficient amount of grafted polyhydroxy copolymer to create a resultant chewing gum that is more environmentally acceptable than a chewing gum without the graft copolymers of polyhydroxy compounds, and adding to the chewing gum base components known in the principles of the art of creating resultant chewing gum products from otherwise standard elastomers.

### BACKGROUND OF THE INVENTION

The present invention relates to the field of chewing gum compositions comprising graft copolymers of monomeric and polymeric polyhydroxy compounds in chewing gum to enhance the degradability of post-consumer use of chewing gum and to enhance and prolong the flavor release characteristics of chewing gum and methods of making same. More specifically, the present invention relates to chewing gum compositions that are more environmentally acceptable, and yield longer time release of flavor characteristics when utilizing encapsulation techniques as compared to typical compositions derived in the past including elastomeric proteins, whey proteins, zein, and vegetable fibers.

Chewed gum is easily disposed of in the wrapper that initially houses the chewing gum. Likewise, chewed gum can be disposed of in other substrates by wrapping the substrate around the chewed gum. Although chewed gum can be easily disposed of without creating any problems, chewed gum improperly disposed of can create environmental concerns. Typical chewing gum, due to its formulation, after it is chewed has adhesive-like characteristics. Therefore, chewed gum can stick to surfaces on to which it is placed. Unfortunately, many consumers do not properly dispose of chewed gum. There is therefore a need for a chewing gum that will degrade and/or can be easily removed from indoor/outdoor surfaces and/or that can be ingested after chewing or will dissolve in the mouth after a period of chewing.

Conventional chewing gums have achieved broad success in the market place. Such chewing gums typically comprise gum base and other components that provide pleasant chewing characteristics. Unfortunately, conventional chewing gums have several drawbacks. Conventional chewing gum bases are not “biodegradable,” or digestible, and disposal of conventional chewing gums can cause unsightly litter. The traditional chewing gum base is typically comprised of a) natural gums, b) synthetic gums, and c) synthetic and natural resins and their derivatives as follows:

a). Natural gums of vegetable origin: Exemplary natural gums include Chick jelutong, gutta Hong Kong, gutta soh, gutta katiau, gutta pontiansk, Niger gutta, yunu chilte, gtta rosa, gutta siak, guar gum, gum Arabic, and guggul gum.

b) Synthetic gums: Exemplary synthetic gums include styrene-butadiene-rubber (SBR Rubber), isobutylene-isopropylene copolymer (butyl rubber), acrylic co-polymers, polyvinylacetate and/or co-polymers thereof.

c) Synthetic and natural resins: Exemplary resins include wood resin esters and ester gums, pentaerythritol esters from wood resin, pentaerythritol esters of partially hydrogenated wood resin, glycerol esters of wood resin, glycerol esters of partially dimerized resin, glycerol esters of polymerized resin, glycerol esters of tall oil resin, glycerol esters of wood resin, glycerol esters of partially hydrogenated wood/gum resin, gycerol esters of partially hydrogenated methyl esters of resin, and terpene resins.

Despite the use of gluten in other fields, gluten's use in the chewing gum field has been hampered by a number of organoleptic factors, and no gluten based chewing gum has gained wide acceptance in the American market, regardless of the advantages of a degradable, edible chewing gum.

More recent chewing gum bases typically contain paraffin, such as liquid paraffin or microcrystalline paraffin wax. However, the presence paraffin in chewing gum bases has a number of disadvantages. Biological degradation of paraffin waxes is slow to negligible. Thus, the wax component of waste chewing gum continues to be environmentally burdensome long after the gum is discarded. Accordingly, it was determined desirable to substitute the paraffin component of conventional chewing gum base while mimicking the physical properties of the conventional chewing gum base. It is thought that graft copolymers, i.e., a polymer in which the main backbone chain of molecular units has side chains attached at various points wherein the side chains contain different molecular units than the main chain, might prove useful as a substitute component in chewing gum base. The patent literature is devoid of references teaching the use of grafted polyhydroxy polymer compounds, hereinafter referred to as “GCPH” as a component in either chewing gum bases or compositions. The non-patent scientific literature is also devoid of teaching suggesting the use of GCPH in chewing gums. For the above mentioned reasons, there is a need to provide polymeric materials that are environmentally safe and edible for human consumption.

Up to the present time, major efforts to develop a biodegradable polymeric chewing gum base have evolved from work originally conceptualized by Alpha Food Ingredients, Inc. the assignee of the present application. The initial premise entailed modifying poly(lactic acid) by 1) synthesis of a dicarboxylic acid terminated poly(lactic acid) (“PLA”) macromer; 2) multiple chain coupling of those PLA macromer units with 1,3-phenylene bis-oxazoline (“PBO”) to yield a high molecular weight modified poly(lactic acid) (“MPLA”). An essential element of the macromeric PLA precursor is that it have a sufficient amount of a “flexibilizing” segment with the ability to “double” the access of the carboxylic acid end groups needed for PBO coupling. Dimer acid [EMPOL 1008 of Henkel Corporation] was found to have both aforementioned attributes.

The final preferred candidate was designated as ALFEX 61 by Alpha Food Ingredients, Inc. the assignee of this application (hereinafter “AFI”). ALFEX 61 consists of a 6:1 molar ratio of lactic acid (LA), with a preferred molar ratio of 2:1 of L(+) to D(−) isomers of lactic acid to dimer acid; the macromeric PLA finally coupled with 1,3 PBO at a 1 to 1 molar ratio of oxazoline to carboxylic acid group. Under contract with ALI, ALFEX 61 was satisfactorily scaled up in commercial equipment at Henkel Corporation, a manufacturer of dimer acid, in Kankakee, Ill.

Utilizing hydrophobic C-36 dimer fatty acid, ranging from a ratio of 6 moles of poly(lactic acid) to 1 mole of C-36 dimer fatty acid in the preferred prior art to a ratio of 1:1, is believed responsible for the very desirable attribute of decreased hydrophilicity. Decreased hydrophilicity is believed to be the attribute that is most probably responsible lower adhesion to hydrophilic surfaces, such as concrete, where ALFEX 61 is incorporated into the chewing “cud.” Additionally, hydrophobic C-36 dimer fatty acid is also believed to have compromised the biodegradability of the chewing gum base as compared to the desired biodegradability of the PLA component.

Contrary to initial impressions, regulatory approval for dimer acid as a food additive component of polymeric chewing gum has been difficult. The presence of 1,3-PBO as a chain coupling agent, despite it's inherently low reactivity which was thought to increase inertness in biological environments, does not appear to translate to acceptance by the U.S. Food and Drug Administration for “food additive” status.

Despite multiple attempts to retain the essence of the ALFEX 61 base polymer, i.e., by scouting alternates to the C-36 fatty acid dimer flexibilizing segment or the PBO as chain coupling agent, none has approached the ALFEX 61 system for the desired qualities of a biodegradable polymeric chewing gum base.

For the above mentioned reasons, it was decided to explore alternate pathways to a biodegradable polymeric chewing gum base. Review of the patent literature highlighted U.S. Pat. No. 5,331,045 titled “Polyvinyl alcohol esterified with lactic acid and process therefore” to E. I. duPont de Nemours on Jul. 19, 1994 as a potential approach to the desired goal of a polymeric chewing gum base. The '045 patent discloses a product and process for producing polyvinyl alcohol (“PVOH”) esterified with lactic acid. Polyvinyl alcohol, e.g., ELVANOL™ (E. I. duPont de Nemours) is commercially prepared by the acid hydrolysis of polyvinyl acetate “PVOAc”.

Polyvinyl alcohol is an environmentally benign, completely water-soluble film-forming polymer. Because of strong inter-chain hydrogen bonding, in common with cellulose, PVOH cannot be melt processed. In contrast to cellulose however, it is soluble in water and films can be cast from water solutions.

The '045 patent proposes that by limited esterification of some of the free hydroxyl groups of PVOH with lactic acid (“LA”) and chains of PLA oligomers, the strong hydrogen bonding inter-chain forces can be overcome and melt processibility becomes possible. The '045 patent also notes that some of the LA derivatized PVOH, depending on mole ratios, can still show a high degree of water sensitivity and in some cases even be water-soluble. More importantly, the '045 patent purposefully limits the number of lactic acid units to an “average of 1.0 to about 3” as a means to reduce entanglement and thus elasticity. Furthermore, the '045 patent purposely limits the degree of grafting to suit the designed applications of films, moldings, and adhesives by the limiting molar ratio of available lactic acid to polyvinyl alcohol.

U.S. Pat. No. 6,153,231 discloses the use of poly(lactic acid)-dimer fatty acid-oxazoline) copolymers as base materials in chewing gum. The copolymers disclosed include, lactic acid copolymers, C-36 dimer acid and 1,3-phenylene bis-oxazoline such as are disclosed in U.S. Pat. Nos. 5,563,238, 5,470,944, and 5,360,892 to Bonsignore et al.

The present invention provides a new, optimal and low cost composition and method of use, which achieves superior performance and new applications over the above-referenced prior art, and others.

### SUMMARY OF THE INVENTION

As used herein, the term “graft copolymers of monomeric and polymeric polyhydroxy compounds” is used within the context of the present invention to include graft copolymers of individual monomeric, individual polymeric polyhydroxy compounds, blends of individual monomeric and polymeric polyhydroxy compounds, blends of multiple monomeric and individual polymeric polyhydroxy compounds, blends of individual monomeric and multiple polymeric polyhydroxy compounds, and blends of multiple monomeric and multiple polymeric polyhydroxy compounds. As used herein the term grafted polyhydroxy copolymers is intended to include all compounds within the above definition and is hereinafter referred to as “GCPH” or “GCPH copolymers”.

In accordance with one aspect of the present invention, graft copolymers of monomeric and polymeric polyhydroxy compounds with a high degree of grafting are provided with unreacted residual monomers or water-soluble low molecular weight oligomers. In accordance with another aspect of the present invention residual unreacted monomers or water-soluble low molecular weight oligomers achieve long lasting sour flavor notes. As used herein the term “low molecular weight oligomers” is intended to mean oligomers with a range of 2-10 units. For example, polylactic acid dimer to decamer of the formula:

H—[OCH(CH₃)CO—]ₙ—OCH(CH₃)COOH

wherein n is an integer between 1 and 9, is considered an example of a low molecular weight oligomer. The term “high degree of graffing” is intended to mean a hydroxyl-substituted grafted copolymer wherein at least 10 of the hydroxyl groups are esterified.

In accordance with a preferred embodiment of the invention, graft copolymers of monomeric and polymeric polyhydroxy compounds with a high degree of grafting are provided with residual unreacted monomers or water-soluble low molecular weight oligomers being removed. A process for extracting unreacted monomers or water-soluble low molecular weight oligomers is utilized. The process entails extracting residual water-soluble unreacted monomers or low molecular weight segments by washing with water, or extraction of unreacted monomers or low molecular weight segments by principles known in the art. Additionally, polyhydroxy graft copolymers with a high degree of grafting are provided and may be co-reacted with residual unreacted monomers or water-soluble low molecular weight oligomers.

Additionally it is desirable to provide a minimal level of crosslinking in the grafted copolymer. As used herein, the term “minimal level of crosslinking” is intended to include where at least 1% of the grafted segments are crosslinked. A partially crosslinked network may be desirable to enhance elastomeric properties of the gum base. Crosslinking either the monomeric and polymeric polyhydroxy grafted copolymer compounds, unreacted monomers, or low molecular weight oligomers is used to form an elastomeric crosslinked network. Crosslinking is preferably accomplished by using a crosslinking agent.

Graft copolymers of monomeric and polymeric polyhydroxy compounds with the highest obtainable degree of grafting are provided. A transesterification catalyst may be employed to enhance the degree of esterification of the copolymer, thereby extending the segment chain length and increasing the conformational entanglement of each chain which results in enhanced elastomeric behavior of the resulting composition. Additionally, a fatty acid terminator may be employed to control the polymer segment length of the inventive copolymer.

The inventive graft copolymers may be prepared into chewing gums bases that mimic the texture and chew properties of conventional chewing gum bases by employing standard conventional methods for compounding chewing gum basis as are known in the art. Such conventional methods include the following: adding gum base components selected from the group elastomers; elastomer plasticizers; fillers; softeners; waxes; antioxidants; colorants; emulsifiers; colors; acidulates; texturing agents; and other components that provide desired attributes and adding time release components selected from the group of flavors; flavoring agents; colors; acidulates; minerals, vitamins and bioactive agents.

The inventive graft copolymers may also include active release agents, including, without limitation, compounds that permit a controlled release of flavor, pharmaceutical, or nutraceutical actives. The process includes the controlled flavor release over an extended duration for either longer lasting flavors and actives or the lower level of expensive flavors and actives.

It is preferable in accordance with another aspect of the present invention to compound the inventive graft copolymers in accordance with known methods for preparing environmentally friendly, human-safe, digestable and/or biodegradeable chewing gum bases. The inventive graft copolymers are further preferably compounded employing conventional methods for making chewing gums that mimic texture and chew properties of conventional bum bases.

In accordance with another aspect of the present invention, the chewing gum bases derived from graft copolymers of monomeric and polymeric polyhydroxy compounds are further prepared into chewing gums utilizing standard principles of making active release chewing gums, that are also human safe and environmentally friendly. As used herein the term “active release” refers to a gum that provides a controlled release of actives selected from the group of flavors, pharmaceutical, and nutraceutical actives. The inventive chewing gum bases are also preferably prepared into chewing gums utilizing standard principles of making environmentally friendly chewing gums. The term “environmentally friendly” is intended to refer to a gum that is biodegradeable and capable of easily being released from indoor or outdoor surfaces. The term “human safe” is intended to refer to a human ingestible gum capable of being swallowed after chewing or will dissolve in the mouth after a period of chewing.

Advantages of the present invention include providing a chewing gum base composition made from a reduced level of gum base components, that is environmentally friendly, biodegradable, is easily releasable from surfaces when improperly discarded, is digestible and has acceptable flavor, texture, sweetness and organoleptic qualities.

Furthermore, an advantage of the present invention is to provide a chewing gum composition containing graft copolymer of monomeric and polymeric polyhydroxy compounds that may be functionalized or encapsulated to include active release or time release properties for bioactive agents, such as pharmaceuticals, nutraceuticals, nutritional compounds, including vitamins and minerals, all of which are capable of being released by chewing the cum or swallowing the gum cud.

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### DETAILED DESCRIPTION OF THE PREFERRED EMBODIMENTS

The present invention provides copolymers with improved elastomeric behavior and methods for making same. There are two essential components in the preferred embodiment of the graft copolymers of monomeric and polymeric polyhydroxy compounds (hereinafter referred to as “GCPH”), disclosed in this invention, onto a polyhydroxy “backbone” to develop elastomeric materials. The presently preferred embodiments of the invention will now be set forth.

Graft copolymers of monomeric and polymeric polyhydroxy compounds are provided with a high degree of grafting that enhance the elastomeric behavior of polyhydroxy copolymer delivery systems.

The term grafted copolymer of polyhydroxy compounds is used interchangeably with the above definition and is hereafter referred to as “GCPH” or “GCPH copolymers”. The preferred composition is influenced by a number of factors, including cost effectiveness, biodegradability, its' ability to mimic and emulate the characteristics within traditional elastomeric applications (e.g., traditional chewing gum bases, edible film coatings, etc.), elasticity, and compatibility with other components in the copolymer delivery systems.

Polyhydroxy Compounds

Polyhydroxy compounds are selected from the group of monomeric polyhydroxy and polymeric polyhydroxy compounds. Preferred monomeric polyhydroxy compounds are further selected from the group of R—(OH)ₙ wherein R is a branched or straight chain alkyl substitutient having between 3 and 12 carbon atoms. One such monomeric polyhydroxy compound is dipentaerythritol, hereinafter referred to as (“DPE”). In accordance with a more preferred embodiment of the invention, preferred compounds include blends of polyhydroxy compounds. One particularly preferred blend comprises 25% of the reactive hydroxyl groups being contributed by DPE and the remaining 75% of the free hydroxyl groups being contributed from PVOH. This blend has demonstrated very good elastomeric properties for a chewing gum base. Preferred polymeric polyhydroxy compounds are preferably selected from the group consisting of polyvinyl alcohol, partially saponified polyvinyl acetates and partially hydrolyzed polyvinyl ethers, polyglycerol. Polyglycerols are preferably selected from the group consisting of diglycerol, triglycerol, monoisopropylidene diglycerol, and monoisopropylidene triglycerol. Particularly preferred polyhydroxy copolymers are selected from the group of hydroxy compounds acceptable as food ingredients. More particularly preferred polyhydroxy compound is polyvinyl alcohol (CH₂—CH—OH)ₙ, hereinafter referred to as “PVOH”. PVOH, one such exemplary is ELVANOL® of duPont starts with polyvinyl acetate (CH2—CH—O—CO)—CH₃), hereafter referred to as “PVOAc”, and subjects it to acid hydrolysis. The reaction formula is

R—O—CO—CH₃+H+→R—OH+CH₃—COOH

The specifically preferred PVOH is classified as “completely” hydrolyzed (essentially 95-98% of the acetate groups removed). “Incompletely” hydrolyzed PVOAc (essentially 83-87% of the acetate groups removed) are also suitable for the production of GCPH graft polymers with similar physical elastomeric properties. Various grades of “completely” hydrolyzed PVOH are available in that the molecular weights are varied. Specifically preferred polyvinyl alcohol is the “medium viscosity” Elvanol® of duPont 70-06, due to its advantage of consistently achieving a rubbery elastomeric material. The last two numbers indicate the viscosity in centipoises of a 4% aqueous solution, therefore the order of decreasing molecular weight is 70-62 followed by 70-06 and subsequently followed by 70-03.

Grafting Segments

Grafting segments are selected from the group α-hydroxyalkanoic acids, β-hydroxyalkanoic acids, and other poly(esters). One such α-hydroxyalkanoic acid exemplary is lactic acid “LA”, where R is CH₃ in the formula R—CH(OH)—COOH. Another such α-hydroxyalkanoic acid exemplary is glycolic acid (“GA)”, where R is H. When R is CH₃ the a carbon is asymmetric, thus the forms of lactic acid are selected from the group of L(+) or D(−) configurations. Exemplary biodegradable homopolymers are selected from the group consisting of polylactides, polyglycolides, poly(p-dioxanones), polycaprolactones, polyhydroxyalkanoates, polypropylenefumarates, polypeptides, and genetically engineered polymers. Preferred biodegradable homopolymers are selected from the group of polylactides, polyglycolides, poly(p-dioxanones), polycaprolactones, and polyhydroxyalkanoates. Exemplary copolymers are selected from the group of poly(lactide-glycolides), poly(p-dioxanone-lactides), poly(p-dioxanone-glycolides), poly(p-dioxanone-lactide-glycolides), poly(p-dioxanone-caprolactones), poly(p-dioxanone-alkylene carbonates), poly(p-dioxanone-alkylene oxides), poly(p-dioxanone-carbonate-glycolides), poly(p-dioxanone-carbonates), poly(caprolactone-lactides), poly(caprolactone-glycolides), poly(hydroxyalkanoates), poly(ester-amides), poly(ester-urethanes), polypeptides and genetically engineered copolymers. Preferred copolymers are selected from the group of poly(lactide-glycolides), poly(p-dioxanone-lactides), poly(p-dioxanone-glycolides), poly(p-dioxanone-lactide-glycolides), poly(p-dioxanone-caprolactones), poly(p-dioxanone-alkylene carbonates), poly(p-dioxanone-alkylene oxides), poly(p-dioxanone-carbonate-glycolides), poly(p-dioxanone-carbonates), poly(caprolactone-lactides), poly(caprolactone-glycolides), poly(hydroxyalkanoates). More preferred grafting segments are selected from the group of lactic acid and glycolic acid as being already acceptable polymers for food and medicinal applications. Particularly preferred grafting segments are derived from an amorphous blend of α-hydroxyalkanoic acids due to their increased resulting flexibility in the graft copolymers. More particularly preferred grafting segments are derived from blends of lactic acid and glycolic acid that yield amorphous poly(ester) segments. Specifically preferred grafting segments are derived from blends of lactic acid in both the L(+) and D(−) configurations and glycolic acid that yield amorphous poly(ester) segments.

The present invention does not preclude the use of alkali or alkaline-earth metal salts for the neutralization of free carboxyl end groups of monomeric and oligomeric carboxyl function species.

The degree of grafting, in addition to the varying percentage of average number of units per grafting segment, alters the GCPH based polymers characteristics such as tensile strength, glass transition temperature, degradation, and flavor release characteristics. There are a number of other ways to modify the GCPH based polymers that are created.

The composition of the present invention is preferably formulated by producing graft copolymers of monomeric and polymeric polyhydroxy compounds with a high degree of grafting and with residual levels of unreacted residual monomers or water-soluble low molecular weight oligomers. It is an object of the invention to retain the residual unreacted monomers or water-soluble low molecular weight oligomers to achieve relatively time limited periods of elastomeric behavior. It is further an object of the invention to retain the residual unreacted monomers or water-soluble low molecular weight oligomers for their unreacted free carboxyl end groups to achieve long lasting sour flavor notes. One such exemplary of applications requiring a sour flavor is the confectionery product industry with it's growing demand for sour tasting products.

Some considerations of hydroxyalkanoate acid polyesterification are, in order, lactic acid self-condensation, lactic acid esterification with a monofunctional alcohol and lactic acid esterification with a polyfunctional alcohol, which are further discussed below.

1. Lactic Acid Self Condensation

Lactic Acid (“LA”) can be considered a typical AB monomer, where A is a hydroxyl group and B is a carboxylic acid group. If 2 moles of LA condense with elimination of a molecule of water, the product is the dimer lactoyllactic acid. The resulting product ABAB still retains the 1 to 1 correspondence between A (a free hydroxyl group) and B (a free carboxylic acid group). There is no inherent difference in reactivity between an A group as part of a monomer unit and an A group that is a terminal hydroxyl group of a growing PLA chain. The same consideration applies to the B group. If many AB molecules are allowed to self condense with liberation of water molecules between A and B groups, the final product would be a single infinitely long polyester nAB→(AB)ₙ+(n−1)H₂O↑, although such result is not practically achievable.

Statistical considerations, such as those enunciated by Paul Flory in Principles of Polymer Chemistry dictate that a distribution of (AB)x oligomers results as the condensation proceeds, however no level of condensation ever avoids the complete elimination of some residual AB monomer units (i.e., lactic acid).

2. Lactic Acid Esterification with a Monofunctional Alcohol

Suppose that LA, an AB monomer, is allowed to react with a monofunctional alcohol, e.g., A1. A1 can react with B, but not with A. If one mole of A1 is allowed to react with one mole of AB, the final product would be one mole of ABA1. Since A1 does not react with A no further condensation is possible. In actuality, condensation of an equimolar mixture of A1 with AB will result in a statistical distribution of a variety of species including some low condensation products of AB, e.g., A-(BA)ₙB-A1 where n=1,2,3 while some A1 remains unreacted. In general A1 is a chain terminator and depending on its mole ratio to AB will effectively limit the growth of the AB polyester. An example of A1 might be an alcohol such as neopentyl alcohol (CH₃)₃C—CH2—OH.

3. Lactic Acid Esterification with a Polyfunctional Alcohol

The considerations that are obtained in the '045 patent involves the esterification of lactic acid with a polyfunctional alcohol, especially PVOH. Suppose that a polyfunctional alcohol, Aₙ, is condensed with an AB monomer. Each of the n OH groups of the Aₙ molecule can react with the B (carboxylic acid group) to form an ester linkage.

Aₙ-1-A-OH+AB→Aₙ-1-A-B-A

Theoretically n moles of AB can react with Aₙ to give

(A-BA)-(A-BA)-(A-BA)ₙ-2

Again for statistical considerations, a complete spectrum of mixed condensation products results including PVOH, i.e., Aⁿ to which are attached low molecular weight segments of lactic acid including single lactic acid units. Note also that no matter how high the ratio of lactic acid units to the OH unit (A) of the PVOH polymer there will be some OH groups of the PVOH which do not have attached LA units or oligomers. At the same time not all of the AB (lactic acid monomer units will react with An but can condense with themselves to form free standing oligomers B-(AB)ₙ-A where n=0-5 or higher. Some considerations relating to PVOH to which are attached LA monomer and oligomers. Depending on reaction conditions and mole ratios of LA to the hydroxyl group of PVOH, a derivatized PVOH may result in which a high preponderance of free OH groups could result in a derivatized PVOH that still shows a moderately high degree of water solubility.

The present invention may also include the steps of reducing or extracting residual unreacted monomers or water-soluble low molecular weight oligomers. As mentioned previously, despite extended polyesterification reaction times it is never possible to avoid the presence of some unreacted monomer or water-soluble low molecular weight oligomers B-(AB)ₙ-A where n is 1 and higher (perhaps up to 5). It is expected that for most human food consumption applications it will be necessary to remove or neutralize these low molecular weight fragments, whose residual carboxylic acid groups could cause objectionable off-tastes (e.g., acid yields sour taste). The compositions of the present invention are also preferably graft copolymers of monomeric and polymeric polyhydroxy compounds with a high degree of grafting and the reduction or removal of any residual unreacted monomers or water-soluble low molecular weight oligomers. A process for extracting unreacted monomers or water-soluble low molecular weight oligomers is utilized. That these monomers and oligomers are water-soluble suggests that a sample mastication of the final polymer with water can extract these low molecular weight components. Furthermore, that these monomers and oligomers have free carboxylic acid end groups suggests that a simple neutralization with an acceptable alkaline agent could neutralize the off taste propensity. The process is selected from the group of extracting residual water-soluble unreacted monomers or low molecular weight segments by washing out with water, and extraction of unreacted monomers or low molecular weight segments by principles known in the art. Exemplary applications where all residual water-soluble unreacted monomers or low molecular weight segments are removed include most food applications (i.e., no desired sour taste) such as traditional chewing gum applications and film coatings.

The present invention does not preclude the co-reacting of residual unreacted monomers or water-soluble low molecular weight oligomers as a means to reduce or eliminate the residual monomers or water-soluble low molecular weight oligomers. The compositions of the present invention are thus also preferably graft copolymers of monomeric and polymeric polyhydroxy compounds with a high degree of grafting with the co-reacting of any residual unreacted monomers or water-soluble low molecular weight oligomers. Calcium carbonate, a common filler and extender for copolymers is useful for the conversion of one such exemplary lactic acid into calcium lactate or the calcium salt of other oligomeric species. The process for co-reacting of unreacted monomers or low molecular weight segments is selected from the group of salt forming minerals, such as calcium carbonate, magnesium carbonate into the mineral salt of other oligomeric species, or the simple neutralization with an acceptable alkaline agent. The use of sub-micron powders such as calcium carbonate serves multiple purposes in the present invention that include: “binding” of unreacted monomers or water-soluble low molecular weight oligomers to eliminate sour taste; extend the GCPH copolymer with an inexpensive filler; and enhance the elasticity of the GCPH copolymer. The use of micron size powders such as calcium carbonate serves multiple purposes in the present invention that include: “binding” of unreacted monomers or water-soluble low molecular weight oligomers to eliminate sour taste; and extend the GCPH copolymer with an inexpensive filler. Exemplary applications where the residual unreacted monomers or water-soluble low molecular weight oligomers are co-reacted include most food applications (i.e., no desired sour taste and copolymer extender) such as traditional chewing gum applications and film coatings.

The present invention does not further preclude the crosslinking of grafted segments as a means to reduce plastic deformation and elastomeric slippage resulting from extended periods of elastomeric stress. It is therefore an object of the invention to enhance the elastomeric behavior to reduce plastic deformation by adhering to the necessary structural features for elastomeric behavior that include: a) the chains must be crosslinked to each one another in some fashion to form a network; b) if no crosslinks are deliberately introduced, entanglement between neighboring chains act effectively as temporary crosslinks, melts of uncrosslinked polymers with long enough chains show a short term elasticity for this reason. The compositions of the present invention are thus also preferably graft copolymers of monomeric and polymeric polyhydroxy compounds with a high degree of grafting and a minimal though sufficient level of crosslinking. A process for crosslinking either the graft copolymers of monomeric and polymeric polyhydroxy compounds, unreacted monomers, or low molecular weight oligomers is achieved to form a crosslinked network for elastomeric behavior. The process for crosslinking of unreacted monomers or low molecular weight segments is achieved using a crosslinking agent. Applying elastomeric stress for a long enough time causes the copolymers to eventually slide past each other and untangle, leading to plastic deformation. Whereas concentrated solutions and gels of flexible polymers are characterized by entanglement points where polymer strands cross and loop around each other. It is therefore an object of the invention to incorporate permanent networks or gels formed by chemical crosslinks to effectively constrain and determine the average distance between points along a given chain by the surrounding network. Exemplary crosslinking agents include poly(carboxylic acid). Preferred poly(carboxylic acids) are selected from the group of food grade poly(carboxylic acids). More preferred poly(carboxylic acids) are selected from the group of poly(carboxylic acids) with two or more carboxyl groups per molecule. Particularly preferred poly(carboxylic acids) are selected from the group of ascorbic acid (Vitamin C) and tartaric acid.

The present invention does not yet further preclude the utilization of transesterification catalysts as means to achieve higher degrees of grafting within the graft copolymers of monomeric and polymeric polyhydroxy compounds. The principle of using transesterification catalysts is known in the art to accelerate the reaction speed and completeness. A process for enhancing the statistical degree of grafting is increased through the inclusion of an esterifying catalyst. A higher degree of grafting achieves enhanced elastomeric behavior due to the increased entanglement. It is therefore an object of the invention to enhance the elastomeric behavior by adhering to the necessary structural features for elastomeric behavior that include: a) the material must be a polymeric material, i.e. be made up of long chain molecules which consist of repeating segments (mers), some of these polymers make good elastomers, but some do not; b) besides having long polymer chains, it is necessary that these chains be mobile, which means there must be easy rotation about C—C bonds (in other words backbone bonds) in the chains; and c) it is also necessary that most of the chains in an elastomer pack randomly together and do not crystallize into a highly crystalline structure, small percentages of crystals however will not destroy the elastomeric properties of a polymer. One such exemplary application where a higher degree of grafting is desired includes most traditional chewing gums.

Preferred transesterification catalysts are selected from the group of food approved catalysts. More preferred transesterification catalysts are selected from the group of tin compounds (Sn++), known to be environmentally benign and widely used for preparing poly(hydroxyalkanoates) esters in pharmaceutical resorbable sutures comprised of polyester fibers (e.g., DEXXON®), p-toluenesulfonic acid, phosphoric acid, polyphosphoric acid, phosphorous pentoxide, sulfuric acid, titanium, copper, Y₅(OiPr)₁₃O, zirconium, silicate of a Group IVB element, titanium n-butoxide, Ti(BuO)₄, Bu2SnO, trimethylsulphonium hydroxide (TMSH), and zinc oxide. A particularly preferred transesterification catalyst is selected from the group of stannous octanoate or stannous chloride. The transesterification catalyst is present in an amount in the range 30 to 1000 parts per million calculated as parts by weight of catalyst with respect to weight of product ester.

The present invention does not yet further preclude the utilization of monofunctional fatty acid terminators as a means to limit and control segment length within the graft copolymers of monomeric and polymeric polyhydroxy compounds. A process for limiting the statistical polymer length of each segment is achieved through the inclusion of a fatty acid terminator. The process of limiting the segment chain length balances the entanglement network of each chain to enhance elastomeric behavior. It is an object of the invention to balance the number of units within each segment to increase entanglement and thus increase elasticity. A further process to increase the number of units within each segment is to increase the mole ratio of monomeric and polymeric grafting components to the polyhydroxy backbone. Fatty acid chain terminators are selected from the group of R—COOH. Preferred monofunctional fatty acid terminators limit the chain length of the grafted segments of poly(esters) and are selected from the group consisting of free fatty acid materials derived from one or more of edible plant and animal fats and oils, lauric acid, stearic acid, isostearic acid, capric acid, caproic acid, palmitic acid, oleic acid, palmitoleic acid, triacontanoic acid, linoleic, linolenic, formic acid, acetic acid, propionic acid, butyric acid, valeric acid, enanthic acid, caprylic acid, and combinations thereof. The preferred monofunctional fatty acid terminators are also selected to mitigate the inherent high hydrophilicity of the base reacting hydroxy compounds and grafting segments of preferred α-hydroxyalkanoic acids components. More preferred monofunctional fatty acid terminators are selected from the group of fatty acids with a chain length of 12 or more carbons, a monofunctional carboxylic acid, and fatty acids with high boiling points relative to water (limit the distillation out with water during manufacturing). A particulary preferred fatty acid terminator is selected from the group of stearic acid, palmitic acid, and lauric acid. A more specifically preferred fatty acid terminator is stearic acid. The invention purposely modifies the condensing polyester by co-reaction with hydrophobic high molecular weight fatty acids to limit the length of the grafted segments, contrary to the teaching of U.S. Pat. No. 5,331,045, which teaches the addition of PLA growth segments for the purpose of interfering with strong hydrogen bonding set up with PVOH thereby transforming PVOH from an intractable non-melting polymer into a melt-processible thermoplastic system.

The present invention does not preclude the GCPH based polymers being ingested for human or animal consumption. It is therefore an object of the present invention to provide graft copolymers of monomeric and polymeric polyhydroxy compounds exclusively from individually monomeric and polymeric hydroxy compounds that are recognized as acceptable food ingredients. It is further an object of the invention to incorporate actives into the GCPH based polymers selected from the group of pharmaceutical actives, nutraceutical actives and nutritional compounds, to be delivered to the consumer. To this end flavors and colorants are anticipated to enhance the consumer appeal or mask off-flavors. Yet further advantages include the surprising characteristics of being soluble in alcohol, easy to remove from physical surfaces to which it is expelled or attached, readily biodegradable, and a superior means to deliver in a controlled manner various actives. The copolymer can be safely incinerated, degraded, eaten and digested or simply disposed of without presenting environmental or toxicity problems. Also, by having the ability to attach/encapsulate flavors, colorants, drugs, nutritional compounds, or other chemical compounds to this polymer, other benefits are realized. For example, drug delivery by way of a copolymer matrix is possible, e.g., the compound attached/encapsulated to the repeating polymer may be a medicament such as a non-steroidal anti-inflammatory drug, an anesthetic or a nutrition compound such as a vitamin.

The principle of manufacturing GCPH copolymers is practiced with the grafting and esterification of components selected from the group of polyhydroxy compounds, grafting segments, co-reactants, crosslinking agents, transesterification catalaysts, monofunctional fatty acid terminators, flavorants and colorants, and combined in proportions all by weight of the copolymer ingredients typically selected from the group of:

The copolymer comprises one or more polyhydroxy compounds in an amount of 1% to 85%; preferred composition ranges are selected from the group of 1% to 50%; more preferred composition ranges are selected from the group of 1% to 20%; the copolymer comprises one or more grafting segments in an amount between 15 to 85%; preferred composition range is between 50 and 85%, with a more preferred composition range being between 60 to 85%; the copolymer comprises one or more grafting segments wherein the grafting segments have an average number of units per grafting segment greater than 3, with a preferred average number of units per grafting segment being greater than 20% of the available branches of free hydroxyl groups; the copolymer comprises one or more co-reactants in an amount of 0% to 85%; preferred composition ranges are selected from the group of 0% to 5% and 10% to 40%; more preferred composition ranges are selected from the group of 15% to 30%;

The copolymer comprises one or more crosslinking agents in an amount of 0% to 15%; preferred composition ranges are selected from the group of 0% to 2%;

The copolymer comprises at one or more transesterification catalysts in an amount of 0% to 1%; preferred composition ranges are selected from the group of 0.01% to 0.3%; more preferred composition ranges are selected from the group of 0.01% to 0.1%;

The copolymer comprises at least one monofunctional fatty acid terminator in an amount between 0.01 to 30%, with the preferred composition including at least one fatty acid terminator present at between 3 and 20%, with the more preferred composition including between 8 to 20% monofunctional fatty acid terminator.

Gum Base

The present invention provides copolymers with improved elastomeric behavior, methods for making same, and methods for making said copolymer into a chewing gum base. The additional method of use as a component in a chewing gum base and its' preferred embodiments of the invention will now be set forth.

The present invention also provides copolymers with improved elastomeric behavior while being generally regarded as safe for human consumption and methods for making same. GCPH based polymers may be added to a gum base or, more preferably, used in gum in place of a typical gum base providing an enhanced delivery vehicle. It is therefore an object of the invention to be an elastomeric material in chewing gum bases, and further resulting chewing gum compositions. It is therefore an object of the invention to utilize GCPH copolymers as an essential component within chewing gum base. The preferred embodiment utilizes GCPH copolymers as an elastomer or as the gum base itself. More preferred embodiment utilizes GCPH copolymers as an elastomer or as the gum base itself with an “acidity” level of less than 2.50 meg/g in order to obtain good physical properties. More particularly preferred embodiment utilizes GCPH copolymers as an elastomer or as the gum base itself with fatty acid chain terminators, such as stearic acid, to retain the flowable thermoplastic polyester physical properties. The present invention does not further preclude the addition of ingredients known in the art of manufacturing chewing gum base formulations and may modify the GCPH copolymer to provide desirable characteristics. The addition of ingredients known in the art of manufacturing chewing gum base formulations are selected from the group of elastomers; elastomer plasticizers; fillers; softeners; waxes; antioxidants; colorants; emulsifiers; acidulants; resins, fats and oils; and other components to provide the desired gum base attributes. The term gum base, as used in the context of the present invention is the elastomeric material that serves as the masticatory substance that historically is insoluble in salvinary fluids and is retained in the mouth throughout the chewing experience.

The present invention does not yet further preclude a chewing gum base composition that incorporates encapsulates of flavor and colorant agents as a means to enhance the consumer appeal due to unique flavor and colorant release characteristics as compared to typical compositions derived. Typical gum flavors and coloring are quickly dissipated during the process of chewing. It is therefore an object of the invention for a chewing gum base to release flavors and/or colorant agents over the duration of the chewing experience. The process includes the controlled flavor and active release over an extended duration for either longer lasting flavors and actives or the lower level of expensive flavors and actives.

The present invention does not preclude the restriction of all components within the GCPH copolymer and additional components in the gum base being individually biodegradable. A more preferred embodiment of the present invention prepares the resulting chewing gum base to mimic the texture and chew properties utilizing standard principles of making chewing gums bases. As used herein the term “standard” refers to a gum base that is manufactured utilizing the prior art principles of making chewing gum bases and typically includes steps selected from the processes of:

Addition of components selected from the group elastomers; elastomer plasticizers; fillers; softeners; waxes; antioxidants; colorants; emulsifiers; colors; acidulants; texturing agents; and other components that provide desired attributes.

Addition of Components Selected from the Group of Minerals, and Vitamins.

Addition of components for time release selected from the group of flavors; flavoring agents; colors; acidulants; minerals, and vitamins.

The present invention does not yet further preclude a chewing gum base composition that incorporates the graft copolymers of polyhydroxy compounds utilizing standard principles of making active release chewing gums bases. As used herein the term “active release” refers to a gum base that provide a controlled release of flavor, pharmaceutical, or nutraceutical actives. The process includes the controlled actives release over an extended duration for sustained delivery of intended actives results.

An advantage of GCPH based copolymers is that they are non-toxic and biocompatible. GCPH copolymers have a characteristic inertness to a wide variety of compounds and food ingredients. Thus, the GCPH copolymers have a wide variety of application. It is therefore an object of the present invention for the graft copolymers of polyhydroxy compounds to be further prepared into chewing gum bases utilizing standard principles of making environmentally friendly chewing gums bases. As used herein the term “environmentally friendly” refers to a gum base that will degrade and can be easily removed from indoor or outdoor surfaces.

The principle of retaining these gum bases as environmentally friendly copolymers is known in the art and typically involves one or more of the following steps: ensuring an absence of non-biodegradable rubbers and resins and adding low molecular weight biodegradable resins where the preferred resins are selected from the group consisting of polyterpenes and wood rosin esters.

Another advantage of GCPH based copolymers is that they can be made entirely of generally regarded as safe food ingredients. Thus, the GCPH copolymers have a wide variety of food applications. It is therefore an object of the present invention for the graft copolymers of polyhydroxy compounds to be further prepared into chewing gum bases utilizing standard principles of making human safe chewing gum bases comprised entirely of generally regarded as safe food ingredients. As used herein the term “human safe” refers to a gum base that can be safely ingested after chewing; and/or will breakdown in the mouth after a period of chewing.

The principle of manufacturing these gum bases derived from GCPH copolymers is known in the art with additional gum base components typically selected from the group of GCPH copolymer comprising about 20 to about 70% by weight of the chewing gum base with the copolymer acting as an elastomer in the traditional chewing gum base, including into the gum base at least one softener selected from the group consisting of cottonseed oil triglycerides, soybean oil, palm oil, palm kernel oil, coconut oil, safflower oil, tallow oil, cocoa butter oil, and medium chain triglycerides; the preferred softener is selected from the group of hydrogenated and non-hydrogenated oils; the more preferred softener is selected from the group consisting of hydrogenated soya oil, glycerol monostearate, capric triglyceride, conjugated linoleic acid, and hydrogenated cotton seed oil; the particularly preferred softener is selected to obtain a melting temperature within the range of 20° C. to 80° C.; the gum base may also include other elastomers to lend a rubbery and cohesive nature to the gum, which properties vary depending upon the chemical structure and how it elastomer is blended with other ingredients. Preferred elastomers are selected from the group of natural rubber, such as smoked or liquid latex and guayule, natural gums such as jelutong, lechi caspi perillo, massaranduba balata, massaranduba chocolate, nispero, rosidinha, chicle, gutta percha, gutta kataiu, niger gutta, tunu, chilte, chiquibul, gutta hang kang, synthetic rubber such as butadiene-styrene copolymers, polyisobutylene, isobutylene-isoprene copolymers, polybutadiene, vinyl polymers such as polyvinyl acetate, polyethylene, vinyl copolymers such as vinyl acetate/vinyl laurate, ethylene/vinyl acetate, polyvinyl alcohol or mixtures thereof; the more preferred elastomers are selected from the group of elastomers including vinyl polymers having a molecular weight less than 2000; the particularly preferred elastomers is excluded from the group of non-degradable elastomers that includes butadiene-styrene copolymers, isobutylene-isoprene copolymers, polybutadiene, polyisobutylene, and vinyl polymeric elastomers (polyvinyl acetate, polyethylene, vinyl acetate/vinyl laurate, vinyl acetate/vinyl stearate, ethylene/vinyl acetate) or mixtures thereof;

The gum base may also be modified to include other elastomer plasticizers to vary the firmness of the gum base by varying their polymer plasticizing strength and softening points, an important consideration when one wants to use flavors that differ in plasticizing strength of the gum base in finished gum; preferred elastomer plasticizers suitable are selected from the group of natural rosin esters such as glycerol ester of partially hydrogenated rosin, glycerol ester of polymerized rosin, glycerol ester of partially dimerized rosin, glycerol ester of rosin, glycerol ester of tall oil rosin, pentaerythritol esters of partially hydrogenated rosin, partially hydrogenated methyl esters of rosin, pentaerythritol ester of rosin, synthetic elastomer plasticizers such as terpene resins derived from alpha-pinene, beta-pinene and/or d-limonene and mixtures thereof; more preferred elastomer plasticizers are selected from the group of terpene and rosin ester resins; particularly preferred elastomer plasticizers include terpene rosin ester ratios of the range from 1:15 to about 15:1; specifically preferred the gum base is free of all elastomer plasticizers;

The gum base may also be modified to include one or more components selected from the group of fillers, fats, and emulsifiers. Where a filler is selected, the filler will be selected to preferably have an average particle size between about 50 nanometers to about 10 microns, with a preferred average particle size between about 0.1 to about 5 microns. Fillers may be utilized to modify the texture of the gum base and aid in processing. Preferred fillers are selected from the group consisting of zein, oat fiber, gluten, casein, cellulose, calcium carbonate, talc, magnesium silicate, carbonates, such as magnesium or calcium carbonate, ground limestone, silicates, such as magnesium or aluminum silicate, clay, alumina, aluminum hydroxide, talc, titanium oxide, mono-, di- and tricalcium phosphate, cellulose polymers, such as ethyl, methyl cellulose, and wood-based organic powders, such as polystyrene, polyethylene, oat fiber, wood fiber, apple fiber, zein, gluten, gliadin, casein, or the like, or mixtures thereof. Preferred fillers include calcium carbonate and talc.

The gum base further preferably includes at least one softener compound to modify the texture of the gum base, cause the hydrophobic and hydrophilic components of the base/chewing gum to be miscible, and introduce sharp melting transitions during chewing in order to optimize the chewability and mouth feel of the gum. The preferred softener compounds are selected from the group of glycerides, fatty acids, plasticizers and plasticizer agents, aqueous sweeteners, emulsifiers. The more preferred glycerides are selected from the group of hydrogenated vegetable oil, nonhydrogenated vegetable oil, lard, hydrogenated tallow, cocoa butter, glycerol monostearate, glycerol triacetate, mono-, di- and triglycerides, acetylated mono-, di- and triglycerides, distilled mono-, partially hydrogenated and fully hydrogenated cottonseed, soybean, palm, palm kernel, coconut, safflower, medium chain triglycerides, acetylated monoglycerides, distilled mono- and diglycerides, acetic acid esters of mono and diglycerides, citric acid esters of mono and diglycerides, lactic acid esters of mono and diglycerides, diacetyl tartaric acid esters of mono- and diglycerides. The particularly preferred glycerides are selected from the group of monoglycerides, diglycerides, acetylated monoglycerides, distilled mono- and diglycerides, acetic acid esters of mono and diglycerides, citric acid esters of mono and diglycerides, lactic acid esters of mono and diglycerides, diacetyl tartaric acid esters of mono- and diglycerides. The preferred fatty acids are selected from the group of stearic palmitic, oleic. It is preferable that the plasticizers, plasticizing agents, and emulsifiers, generally constitute between approximately 0.5 to about 15% by weight of the chewing gum and are selected from the group of caproic, caprylic, myristic, lauric and palmitic fatty acids of the triglycerides, glycerin, lecithin. Sweeteners may be selected from the group consisting of erythritol, sorbitol, hydrogenated starch hydrolysates, starch hydrolysates, hydrogenated starch hydrolysates, corn syrup or combinations thereof. The inclusion of triglycerides is preferred due to their known secondary effects of lowering serum cholesterol levels, their implication in reducing cancer risks, and increased calcium uptake. Preferred triglycerides are selected from the group of seed oils rich in Omega-3's, conjugated linoleic acid, and hemp seed oils.

The gum base preferably includes texturing agents to modify the elastic bonding network of the polymer without disrupting the GCPH matrix; preferred texturing agents are selected from the group of carbohydrates, proteins, and grain flours; more preferred texturing agents are selected from the group of glutinous rice flour, bread flour, cornstarch, whey protein concentrates, rice protein concentrates, and combinations thereof;

The base includes acidulants as flavor and flavor enhancers selected from the group of edible acids; the preferred acids include acetic, citric, lactic, and ascorbic acid;

The base includes waxes to aid in the curing of the gum made from the gum base as well as improved shelf-life and texture, whereby the smaller crystal size enables slower release of flavor relative to waxes with larger crystal sizes, and are selected from the group of petroleum waxes, synthetic waxes, and combinations thereof; more preferred waxes are selected from the group of normal-alkanes, straight-chained alkanes, iso-alkanes, branched chain alkanes, branched alkanes copolymerized with monomers, Fischer-Tropsch type waxes; particularly preferred waxes are selected from the group having carbon chain lengths greater than about 30; exemplary monomers of branched alkanes copolymerized with monomers are propylene and polyethylene; specifically preferred waxes are selected from the group of non-petroleum waxes;

The base includes antioxidants for exemplary purposes of extending shelf-life and reducing rancidity of oils, and are selected from the group of antioxidants generally regarded as safe; preferred antioxidants are selected from the group of butylated hydroxyanisole (BHA), butylated hydroxytoluene (BHT), beta-carotenes, tocopherols, acidulants such as Vitamin C, propyl gallate, other synthetic and natural types of mixtures thereof; more preferred antioxidants are selected from the group of butylated hydroxyanisole (BHA), butylated hydroxytoluene (BHT), tocopherols, or mixtures thereof;

The base includes flavorants and colorants for exemplary purposes of impart specific flavor profiles, and removing or masking undesired characteristics; exemplary flavorants are cocoa powder; enzymatically modified oils and cocoa butter, fats, and triglycerides, and lipolyzed modified oils fats and triglycerides; heat-modified amino acids; partially defatted proteins, vegetable extracts, natural extracts (e.g., citrus oils, fruit essences, peppermint oil, spearmint oil, clove oil, oil of wintergreen, anise), artificial flavorants and combinations thereof; exemplary colorants are FD&C type lakes, plant extracts, fruit and vegetable extracts and titanium dioxide and combinations thereof; preferred flavorants and colorants levels are present from about 0% to 15% by weight, and are more fully and evenly released by the gum base of the present invention;

The base includes other agents to impart exemplary properties such as organoleptic, processing, nutritional, and medicinal; exemplary other agents are hydrocolloids (e.g., agar, acacia, guar, carrageenan, pectin and alginates), amino acids (e.g., cysteine and protein hydrolysates), magnesium stearate, microcrystalline cellulose, antimicrobial agents (e.g., chitin, copper, chitosan, sorbates, benzoates and propionates), celluloses (e.g., cellulose gum), chelating agents, dough conditioners and release agents, enzymes (e.g., amylases, cellulases and proteases), grains and flours (e.g., wheat, rice, barley, buckwheat and pea), proteins (e.g., peanut, cashew, lactal-bumin, oval-bumin, and milk solids), carbohydrates (e.g, maltodextrins, dextrins and hydrogenated starch hydrolysates), bulk fillers (e.g., dietary fiber, yeast cell walls), humectants (e.g., glycerin, erythritol, sorbitol, propylene glycol, 1-3hexylene glycol, triacetin, fruit concentrate sweetener composition comprises a blend of a hydrolyzed starch having a dextrose equivalent (D.E.) of up to 25), starches (e.g., corn, wheat and modified starches; fruits, dried fruits and fruit concentrates), film forming agents (e.g., zein, carboxymethyl cellulose, chitin, and chitosan), vegetable gums (e.g., xanthan);

The principle of manufacturing these gum bases derived from GCPH copolymers is known in the art with additional gum base components selected from the group of elastomers, fillers, softeners, fats, emulsifiers, elastomer plasticizers, texturing agents, waxes, acidulants, flavorants and colorants, antioxidants, and other agents to impart exemplary properties such as organoleptic, processing, nutritional, and medicinal combined in proportions all by weight of the gum base ingredients typically selected from the group of:

The gum base comprises one or more GCPH copolymers in an amount of 1% to 99%; preferred composition ranges are selected from the group of 1% to 30%, 40% to 90%; more preferred composition ranges are selected from the group of 55% to 80%. The gum base also preferably comprises one or more elastomers in an amount of 0% to 99%; preferred composition ranges are selected from the group of 1% to 40%; more preferred composition ranges are selected from the group of 1% to 15%; particularly preferred composition ranges are selected from the group of 0% to 5%. One or more fillers may be included in the gum base composition in an amount of 1% to 80%; preferred composition ranges are selected from the group of 1% to 15%, 25% to 80%; more preferred composition ranges are selected from the group of 30% to 50% when said gum base is used for non-antacid functions; more preferred composition ranges are selected from the group of 50% to 80% when said gum base is used for antacid functions. Softeners may be included in an amount of 0% to 15%; preferred composition ranges are selected from the group of 1% to 5%, as may fats be included in an amount of 0% to 15%; preferred composition ranges are selected from the group of 0% to 5% and 10% to 15%; more preferred ranges are selected between 0% to 5% when said fat is not cocoa butter; more preferred ranges are selected between 10% to 15% when said fat is cocoa butter.

The gum base comprises one or more emulsifiers in an amount of 0% to 15%; preferred composition ranges are selected from the group of 0% to 5%. Elastomeric plasticizers may be included in an amount of 0% to 40%; preferred composition ranges are selected from the group of 1% to 15%; more preferred composition ranges are selected from the group of 0% to 5%. Furthermore, texturing agents may be included in an amount of 1% to 80%; preferred composition ranges are selected from the group of 1% to 20%, 30% to 80%; more preferred composition ranges are selected from the group of 30% to 80%.

Waxes in an amount of 0% to 15% may also be included in the inventive gum base composition, with preferred composition ranges are selected from the group of 0% to 10%; more preferred composition ranges are selected from the group of 0% to 5%. The inventive gum base may also comprise one or more acidulants in an amount of 0% to 15%; preferred composition ranges are selected from the group of 0% to 5%, one or more flavorants in an amount of 0% to 25%; preferred composition ranges are selected from the group of 0% to 5% and 15% to 25%; more preferred ranges are selected between 0% to 5% when said flavorant is not cocoa powder; more preferred ranges are selected between 10% to 15% when said flavorant is cocoa powder, one or more colorant in an amount of 0% to 15%; preferred composition ranges are selected from the group of 0% to 5%.

Antioxidant compounds may be included in an amount of 0% to 5% with preferred composition ranges of antioxidant being between 0% to 2%, biologically active compounds, such as vitamins and minerals, pharmaceuticals and/or nutraceuticals may be included in an amount between about 0% to 5.

The principle of manufacturing these gum bases derived from GCPH copolymers is known in the art with amounts as determined by in the preferred embodiment and then subjected to process steps selected from the group of:

The gum base ingredients selected from the group of elastomer, elastomer plasticizer, filler, and vinyl polymer are mixed first with mixing times being dependent on desired softness of gum base, molecular weight, degree of crosslinking, and process temperature;

The gum base is then further compounded with ingredients selected from the group of softeners, emulsifiers, elastomer plasticizers, texturing agents, waxes, acidulants, colorants, antioxidants, and other agents to impart exemplary properties such as organoleptic;

The gum base is then further compounded with ingredients selected from the group of fats, oils, flavorants, pharmaceutical actives, nutraceutical actives, and nutrients; preferred fats, oils, flavorants, pharmaceutical actives, nutraceutical actives, and nutrients are further encapsulated to achieve the purpose selected from the group of time release, mask off-flavors, protect from premature breakdown in mouth, digestive tract, and stomach;

Chewing Gum

The principle of manufacturing chewing gums; whereas chewing gum as used in the context of the present invention, also includes bubble gum; whereas the gum consists of two major components: 1) the chewing gum base and 2) a non-masticatory part, consisting mainly of sweeteners, softeners and flavor ingredients; and whereas the chewing gum is derived from GCPH copolymer gum bases is known in the art with additional gum components typically selected from the group of:

The gum mass always comprises one or more GCPH copolymers gum base in an amount of 10% to 60%; preferred composition ranges are selected from the group of 25% to 42%;

The gum mass comprises one or more components selected from the group of flavors, bulk sweeteners, high intensity sweeteners, low caloric bulking agents and combinations thereof; preferred bulk sweeteners are selected from the group of sugar sweeteners, sugarless sweeteners, and combinations thereof; preferred high intensity sweeteners are selected from the group of artificial sweeteners, natural intense sweeteners, and peptide sweeteners; more preferred high intensity artificial sweeteners are subjected to encapsulation by such techniques selected from the group of wet granulation, wax granulation, spray drying, spray chilling, fluid bed coating, coacervation, fiber extension, micro-encapsulation, cyclodextrin “encapsulation”; where as exemplary sugar sweeteners are saccharides (e.g. sucrose, dextrose, maltose, dextrin, dried invert sugar, fructose, levulose, galactose, corn syrup solids); whereas exemplary sugarless sweeteners are sugar alcohols (e.g., erythritol, sorbitol, mannitol, xylitol, hydrogenated starch hydrolysates, maltitol), whereas exemplary high intensity artificial sweeteners are sucralose, aspartame, salts of acesulfame, alitame, thaumatin, saccharin and its salts, cyclamic acid and its salts, glycyrrhizin, dihydrochalcones, thaumatin, monellin, and where as exemplary low caloric bulking agents are: polydextrose; oligofructose; fructooligosaccharide; palatinose oligosaccharide; natural carbohydrate gum hydrolysate; or indigestible dextrins;

The gum mass comprises one or more flavorants and colorants for exemplary purposes that impart specific flavor profiles, and removing or masking undesired characteristics; exemplary flavorants are cocoa powder; enzymatically modified oils and cocoa butter, fats, and triglycerides, and lipolyzed modified oils fats and triglycerides; heat-modified amino acids; partially defatted proteins, vegetable extracts, natural extracts (e.g., citrus oils, fruit essences, peppermint oil, spearmint oil, clove oil, oil of wintergreen, anise), artificial flavorants and combinations thereof; exemplary colorants are FD&C type lakes, plant extracts, fruit and vegetable extracts and titanium dioxide and combinations thereof; preferred flavorants and colorants levels are present from about 0% to 15% by weight, and are more fully and evenly released by the gum base of the present invention;

The gum mass comprises one or more components selected from the group of pharmaceutical actives, nutraceutical actives, minerals, and vitamins;

The gum mass comprises one or more components selected from the group of encapsulated pharmaceutical actives, nutraceutical actives, minerals, and vitamins to make an actives release chewing gum, whereas term “active release” refers to a gum that provides a controlled release of flavor, pharmaceutical, or nutraceutical actives;

The gum mass comprises only biodegradable components to make an environmentally friendly chewing gums, whereas the term “environmentally friendly” refers to a gum that will degrade and can be easily removed from indoor or outdoor surfaces;

The gum mass comprises only generally regarded as safe food ingredients components making a gum that is safe for human ingestion, digestion, and consumption, whereas the term “safe for human” refers to a gum that can intentionally or accidentally be ingested after chewing and/or will degrade in the mouth, digestive tract, small intenstine, large intestine, or stomach;

The base includes acidulants as flavor and flavor enhancers selected from the group of edible acids; the preferred acids include acetic, citric, lactic, and ascorbic acid;

The principle of manufacturing these gum bases derived from GCPH copolymers is known in the art with additional gum base components selected from the group of gum bases, sweeteners, acidulants, flavorants and colorants, and other agents to impart exemplary properties such as organoleptic, processing, nutritional, and medicinal combined in proportions all by weight of the gum base ingredients typically selected from the group of:

The gum always comprises one or more GCPH copolymer gum bases in an amount of 10% to 99%; preferred composition ranges are selected from the group of 10% to 40%, and 60% to 90%; more preferred composition ranges are selected from the group of 24% to 40% for caloric gums; more preferred composition ranges are selected from the group of 90% to 99% for low-caloric gums;

The gum always comprises one or more sweeteners and combinations thereof in ranges selected from the group of 1% to 80%; preferred ranges for bulk sweeteners are 5% to 95%; more preferred ranges for bulk sweeteners are 20% to 80%; particularly preferred ranges for bulk sweeteners are 30% to 60%; preferred ranges for artificial sweeteners are 0.02% to 8%; preferred ranges for high intensity sweeteners are 0.02% to 0.3%.

The principle of manufacturing these gums derived from GCPH copolymer gum bases is known in the art with amounts as determined in the preferred embodiment and then subjected to process steps selected from the group of:

The gum ingredients selected from the group of gum base, sweeteners, additional softeners are mixed first with mixing times being dependent on desired softness of gum base, gum base molecular weight, and process temperature;

The remaining gum ingredients are added sequentially to minimize processing and temperature exposure in a mixer known in the art that typically include flavorants, colorants, acidulants, and actives selected from the group of pharmaceutical, nutraceutical, and nutrional;

The high intensity sweetener is preferably added after the final portion of bulking agent and flavor have been added;

The gum mass is discharged from the mixer and shaped into the desired form such as by rolling into sheets and cutting into sticks, extruded into chunks or casting into pellets;

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims. All of the examples below are hereinafter referred to as group and known as grafted monomeric and polymeric polyhydroxy copolymers, gum bases made from the grafted monomeric and polymeric polyhydroxy copolymers, and chewing gums made from the grafted monomeric and polymeric polyhydroxy copolymers.

### EXAMPLES

### Example 1

Sample Preparation of Polyvinyl Alcohol Lactic Acid Graft Copolymer

In a 1000 ml reaction kettle was placed 50.1 g of polyvinyl alcohol “PVOH” [Elvanol 70-06 provided by E. I. duPont de Nemours Co.] and 425 ml of water. The reaction kettle was fitted with nitrogen sparge to maintain an inert atmosphere, a Dean Stark modified Barrett receiver and water condenser to collect water of solution and reaction, and an efficient paddle stirrer. The reaction kettle was heated by an external silicone oil bath.

When the PVOH had dissolved, 500 g of lactic acid (68/32 mole ratio of L(+) to D(−)) 86-87% active was added and the condensation allowed to proceed with continual distillation of water of solution and esterification. The ratio of lactic acid “LA” to PVOH is noted as 3.36/1 mole ratio. Ten drops of stannous octoate was added after eight hours reaction time at atmospheric pressure as an esterification catalyst and the reaction allowed to continue while water aspirator vacuum was applied. Note the silicone oil bath temperature was maintained circa 165° C. The extent of reaction was determined by acid base titration of free carboxylic acid content after an additional 2½ hours of reaction time. The product at this stage of condensation was a very viscous liquid with a free carboxylic acid content of 4.04 meg/g. The graft copolyester was very sticky to the touch.

The first stage reaction product was further condensed by bubbling a vigorous stream of nitrogen through the hot melt held a silicone oil bath temperature of 170° C. for four hours. The isolated product on cooling was an extremely tough non-tacky thermoplastic polyester. The polymer was completely soluble in a 50/50 volume basis mixture of chloroform and methanol. Titration with 0.50N KOH in methanol showed a free carboxylic acid content of 2.11 meg/g.

### Example 2

Water Extraction of Low Molecular Weight Carboxylic Acid Fragments

A sample of the above PVOH/PLA graft copolymer with a nominal free carboxylic acid content of 2.13 meg/g was macerated with water until no titratable acidity was released. The water treated polymer still had appreciable “guts” although it pulled and stretched like “seawater taffy”. The polymer still dissolved easily in chloroform and methanol and showed very low titratable acidity of less than 3 drops 0.50N KOH.

### Example 3

Standard esterification process with grafts of lactic acid utilized with xylene (an azeotroping agent) and without fatty acid terminator or transesterification catalyst resulted in a low molecular weight polymer. Physical properties are not suitable for gum base.

### Example 4

Standard esterification process with grafts of lactic acid utilized without xylene, fatty acid terminator, or transesterification catalyst resulted in a very high molecular weight polymer. Physical properties are tough, nervy polymer with low solubility.

### Example 5

Standard esterification process with grafts of lactic acid utilized without xylene, fatty acid terminator, or transesterification catalyst resulted in a soupy, and tacky copolymer with flow of cold molasses at 4.04 meg/g acidity. Continued esterification yielded a dry and non-tacky copolymer with good elasticity. Physical properties are tough, nervy, elastic polymer.

### Example 6

Standard esterification process with grafts of lactic acid and glycolic acid utilized without xylene, fatty acid terminator, or transesterification catalyst eventually resulted in a high molecular weight copolymer at which point loss solubility in benzyl alcohol or chloroform. Continued esterification yielded a dry and non-tacky copolymer with good elasticity. Physical properties are tough, nervy, elastic polymer.

### Example 7

Standard esterification process with grafts of equimolar ratio of lactic acid and glycolic acid utilized without xylene, fatty acid terminator, but with transesterification catalyst (stannous octoate) resulted in a high molecular weight copolymer. Yielded a tough, rubbery copolymer with good elasticity.

### Example 8

Standard esterification process with grafts of lactic acid and glycolic acid (68/32) utilized without xylene, but with fatty acid terminator (high levels of stearic acid) and transesterification catalyst (stannous octoate) resulted in a high molecular weight copolymer. Yielded a stiff, brittle copolymer.

### Example 9

Standard esterification process with grafts of lactic acid and glycolic acid (68/32) utilized without xylene, but with fatty acid terminator (50% reduced level of stearic acid) and transesterification catalyst (stannous octoate) resulted in a high molecular weight copolymer. Yielded a high degree of toughness, stretchy copolymer with no tendency to break when flexed.

### Example 10

Standard esterification process of 66 g of PVOH “70-06” with grafts of lactic acid (360 g of L(+)) utilized without xylene, but with fatty acid terminator (65 g of stearic acid) and transesterification catalyst (stannous octoate) resulted in a higher molecular weight copolymer. Yielded a high degree of toughness, stretchy copolymer with no tendency to break when flexed and excellent acidity levels.

### Example 11

Standard esterification process of 33 g of PVOH “70-62” with grafts of lactic acid (360 g of L(+)) utilized without xylene, but with fatty acid terminator (65 g of stearic acid) and transesterification catalyst (stannous octoate) resulted in a high melt viscosity copolymer. Yielded good, but not excellent acidity levels.

### Example 12

Standard esterification process of PVOH with grafts of lactic acid utilized without xylene, but with fatty acid terminator (stearic acid) and transesterification catalyst (stannous octoate) resulted in a higher molecular weight copolymer. Susbequent co-reacting of copolymer with sub-micron calcium carbonate. Yielded a high degree of toughness, stretchy copolymer with increased flexibility.

### Example 13

Standard esterification process of PVOH with grafts of lactic acid utilized without xylene, but with fatty acid terminator (stearic acid), transesterification catalyst (stannous octoate) also prepared with crosslinking agent (ascorbic acid).

### Example 14

A gum base is prepared having copolymer of Example 1 and is further compounded with sub-micron-sized particulate calcium carbonate, acetic acid esters of mono and diglycerides, and peppermint.

### Example 15

A gum base is prepared having copolymer of Example 1 and is further compounded with talc (sub-micron), acetic acid esters of mono and diglycerides, and peppermint oil.

### Example 16

A gum is prepared having gum base of Example 14 and is further compounded with erythritol, acetic acid esters of mono and diglycerides, peppermint oil, and glycerin.

### Example 17

A gum is prepared having gum base of Example 14 and is further compounded with erythritol, acetic acid esters of mono and diglycerides, cocoa powder, vanilla powder, and glycerin.

While the foregoing examples are illustrative of various embodiments of the invention, those of ordinary skill in the art will understand and appreciate that such examples are non-limiting and that variations in for example, grafted segments, weight percentages, relative percentages, complementary chewing gum base ingredients, complementary chewing gum ingredients, manufacturing processes and conditions are contemplated and included within the scope of the present invention which is limited only by the claims appended hereto.

What is claimed is:

1. An edible chewing gum base composition, comprising grafted polyhydroxy copolymers.

2. The composition according to claim 1, where the grafted polyhydroxy copolymers are selected from the group consisting of polyhydroxy-substituted monomers, polyhydroxy-substituted polymers, and blends thereof.

3. The composition according to claim 1, further comprising grafting segments selected from the group of α-hydroxyalkanoic acids, β-hydroxyalkanoic acids and polyesters.

4. The composition according to claim 2, wherein the grafted polyhydroxy copolymers further comprise at least one of unreacted polyhydroxy-substituted monomers and water-soluble low molecular weight oligomers.

5. The composition according to claim 2, wherein the grafted polyhydroxy copolymers further comprise at least one of a high degree of grafting and a low level of crosslinking.

6. The composition according to claim 2, further comprising a fatty acid terminating a segment length of the polyhydroxy graft copolymer.

7. The composition according to claim 2, further comprising at least one gum base component selected from the group consisting of elastomers, plasticizers, fillers, softeners, waxes, antioxidants, colorants, emulsifiers, acidulates, texturing agents, flavoring agents, sweeteners, vitamins, minerals and bioactive agents.

8. The composition according to claim 1, wherein the grafted polyhydroxy copolymer further comprises grafting segments selected from the group of α-hydroxyalkanoic acids and β-hydroxyalkanoic acids.

9. The composition according to claim 7 wherein the α-hydroxyalkanoic acid comprises a compound having the general formula
R—CH(OH)—COOH
wherein R is a substituent group selected from H, branched or straight chain alkyl groups having 3-12 carbon atoms.

10. The composition according to claim 8 wherein the α-hydroxyalkanoic acid is selected from the group of lactic acid and glycolic acid.

11. The composition according to claim 2, wherein the polyhydroxy-substituted polymers are selected from the group consisting of polylactides, polyglycolides, poly(p-dioxanones), polycaprolactones, polyhydroxyalkanoates, polypropylenefumarates, polypeptides.

12. The composition according to claim 10 wherein the polylactides are further selected from the group consisting of polylactide-glycolides, poly(p-dioxanone) lactides, poly(p-dioxanone) glycolides), poly(p-dioxanone) lactide-glycolides, poly(p-dioxanone) caprolactones, poly(p-dioxanone)alkylene carbonates, poly(p-dioxanone) alkylene oxides, poly(p-dioxanone) carbonate-glycolides, poly(p-dioxanone) carbonates, polycaprolactone lactides, polycaprolactone glycolides, polyhydroxyalkanoates, polyester amides, polyester urethanes, and polypeptides.

13. The composition according to claim 2 wherein the polyhydroxy copolymers are selected from the group of copolymers consisting polylactide-glycolides, poly(p-dioxanone) lactides, poly(p-dioxanone) glycolides), poly(p-dioxanone) lactide-glycolides, poly(p-dioxanone) caprolactones, poly(p-dioxanone)alkylene carbonates, poly(p-dioxanone) alkylene oxides, poly(p-dioxanone) carbonate-glycolides, poly(p-dioxanone) carbonates, polycaprolactone lactides, polycaprolactone glycolides, polyhydroxyalkanoates, polyester amides, polyester urethanes, and polypeptides.

14. A chewing gum base composition comprising grafted polyhydroxy copolymers are selected from the group consisting of polyhydroxy-substituted monomers, polyhydroxy-substituted polymers, and blends thereof.

15. The chewing gum base composition according to claim 13, wherein the polyhydroxy compounds are present in an amount between 1% to 85% by weight of the gum base composition.

16. The chewing gum base composition according to claim 13, wherein the grafted polyhydroxy copolymers further comprise an average number of units per grafting segment is greater than 3.

17. The chewing gum base composition according to claim 15, wherein the grafted polyhydroxy copolymers further comprise an average number of units per grafting segment greater than 20% of the available number of branches having free hydroxyl groups.
